(19) United States
(12) Patent Application Publication
(10) Pub. No.: US 2023/0398959 A1
(43) Pub. Date: Dec. 14, 2023

(54) SYSTEMS AND METHODS FOR GRANTING ACCESS TO AUTONOMOUS VEHICLES

(71) Applicant: TuSimple, Inc., San Diego, CA (US)

(72) Inventors: Robert Patrick Brown, San Diego, CA (US); Gary Lee McCarthy, JR., Flower Mound, TX (US); Christopher Xavier Miller, San Diego, CA (US); Joyce Tam, Pleasanton, CA (US)

(21) Appl. No.: 18/323,231

(22) Filed: May 24, 2023

Related U.S. Application Data
(60) Provisional application No. 63/366,320, filed on Jun. 13, 2022.

(51) Int. Cl. B60R 25/24; B60R 25/01; B60R 25/31

(52) U.S. Cl. CPC B60R 25/241; B60R 25/01; B60R 25/31

(57) ABSTRACT

Systems and methods for granting access to autonomous vehicles are disclosed. In one aspect, an autonomous vehicle includes an access sensor located on an exterior of the autonomous vehicle and configured to receive user credentials from an authorized user, a door configured to provide access to the autonomous vehicle, and a network communications subsystem configured to communicate with a remote oversight system. The autonomous vehicle further includes a processor configured to receive the user credentials from the access sensor, transmit the user credentials to the oversight system via the network communications subsystem, receive a confirmation from the oversight system that the user credentials are associated with a user authorized to access the autonomous vehicle, and unlock the door in response to receiving the confirmation to provide the user access to the autonomous vehicle.

### CROSS-REFERENCE TO RELATED APPLICATION(S)

This application claims the benefit of U.S. Provisional Application No. 63/366,320, filed Jun. 13, 2022. The foregoing application is hereby incorporated by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure relates generally to autonomous vehicles. More particularly, the present disclosure is related to systems and methods for granting access to an autonomous vehicle during an emergency.

### Description of the Related Technology

One aim of autonomous vehicle technologies is to provide vehicles that can safely navigate towards a destination with limited or no driver assistance. The safe navigation of an autonomous vehicle (AV) from one point to another may include the ability to signal other vehicles, navigating around other vehicles in shoulders or emergency lanes, changing lanes, biasing appropriately in a lane, and navigating all portions or types of highway lanes. Autonomous vehicles may be configured to pull over to the side of the road during an emergency situation.

### SUMMARY OF CERTAIN INVENTIVE ASPECTS

One inventive aspect is an autonomous vehicle comprising: an access sensor located on an exterior of the autonomous vehicle and configured to receive user credentials from an authorized user; a door configured to provide access to the autonomous vehicle; a network communications subsystem configured to communicate with a remote oversight system; and a processor configured to: receive the user credentials from the access sensor; transmit the user credentials to the remote oversight system via the network communications subsystem; receive a confirmation from the remote oversight system that the user credentials are associated with a user authorized to access the autonomous vehicle; and unlock the door in response to receiving the confirmation to provide the user access to the autonomous vehicle.

The processor can be further configured to: transmit a location of the autonomous vehicle to the remote oversight system, wherein the remote oversight system is configured to confirm that the autonomous vehicle is located at substantially a same location as the user prior to granting access to the autonomous vehicle.

The processor can be further configured to: transmit a confirmation that the autonomous vehicle is in an emergency condition to the remote oversight system, wherein the remote oversight system is further configured to confirm that the autonomous vehicle is in the emergency condition prior to granting access to the autonomous vehicle.

The autonomous vehicle can further comprise a quick response (QR) code on the autonomous vehicle, the QR code configured to be scanned by a mobile device and direct the mobile device to a webpage that provides access to a method for authenticating the user.

The QR code can further encode information identifying the autonomous vehicle, the mobile device configured to provide the information identifying the autonomous vehicle to the remote oversight system.

The QR code can further encode information to direct the mobile device to establish two-way communication with an operator at the remote oversight system.

The autonomous vehicle can further comprise: vehicle information located on a visible portion of the autonomous vehicle, the vehicle information comprising human-readable contact information for establishing two-way communication with an operator at the remote oversight system.

The vehicle information can further include a phone number to establish the two-way communication and identification information for the autonomous vehicle that the user can relay to the operator to identify the autonomous vehicle.

The autonomous vehicle can further comprise: a communication device configured to establish two-way communication with an operator at the remote oversight system.

The communication device can comprise a microphone and a speaker.

Another aspect is an oversight system comprising: a network communications subsystem configured to communicate with an autonomous vehicle; and a processor configured to: receive user credentials for a user requesting access to the autonomous vehicle via the network communications subsystem; provide the user credentials to a database; receive a response from the database indicating that the user is authorized to access the autonomous vehicle; and transmit a confirmation that the user is authorized to access the autonomous vehicle to the autonomous vehicle via the network communications subsystem.

The processor can be further configured to receive the user credentials from the autonomous vehicle.

The processor can be further configured to receive the user credentials from a mobile device of the user.

The user can be a law enforcement officer (LEO) associated with a law enforcement agency, and wherein the processor is further configured to: request an operator to contact the law enforcement agency to confirm that the LEO is currently on duty and is deployed to an area in which the autonomous vehicle is stopped, wherein transmitting the confirmation that the user is authorized to access the autonomous vehicle is further in response to receiving a confirmation that the LEO is currently on duty and is deployed to the area in which the autonomous vehicle is stopped.

The processor can be further configured to: provide a two-factor authentication (2FA) code to the law enforcement agency; and receive the 2FA code from the LEO, wherein transmitting the confirmation that the user is authorized to access the autonomous vehicle is further in response to receiving the 2FA code from the LEO.

The processor can be further configured to: receive a request from the user to designate a third party with access to the autonomous vehicle; and transmit a command to the autonomous vehicle to grant access to the third party.

Another aspect is a method for granting access to an autonomous vehicle during an emergency, comprising: receiving a user credentials from an access sensor of the autonomous vehicle; transmitting the user credentials to a remote oversight system via a network communications subsystem of the autonomous vehicle; receiving a confirmation from the remote oversight system that the user credentials are associated with a user authorized to access the autonomous vehicle; and unlocking the door in response to receiving the confirmation to provide the user access to the autonomous vehicle.

The method can further comprise revoking access to the autonomous vehicle after a predetermined amount of time since access to the autonomous vehicle was granted.

The method can further comprise: informing the user that access will be revoked; and providing the user an option to extend the predetermined amount of time.

The method can further comprise: determining that the user has spoofed an authorized user and is not authorized to gain access to the autonomous vehicle; and revoking access to the autonomous vehicle including preventing control inputs to the autonomous vehicle from controlling the autonomous vehicle and locking the door from opening from outside in response to determining that the user is not authorized to gain access to the autonomous vehicle.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a system including an autonomous vehicle.

FIG. 2 shows a flow diagram for operation of an autonomous vehicle (AV) safely in light of the health and surroundings of the AV.

FIG. 3 illustrates a system that includes one or more autonomous vehicles, a control center or oversight system with a human operator (e.g., a remote center operator (RCO)), and an interface for third party interaction.

FIG. 4 illustrates an example autonomous vehicle having one or more components configured to grant access to the autonomous vehicle in accordance with aspects of this disclosure.

FIG. 5 is a flowchart illustrating a method for granting access to an autonomous vehicle in accordance with aspects of this disclosure.

FIG. 6 is a flowchart illustrating a method for confirming that an authorized user is authorized to access an autonomous vehicle in accordance with aspects of this disclosure.

### DETAILED DESCRIPTION

Vehicles traversing highways and roadways are legally required to comply with regulations and statutes in the course of safe operation of the vehicle. For autonomous vehicles (AVs), particularly autonomous tractor trailers, the ability to recognize a malfunction in its systems and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

Aspects of this disclosure relate to systems and techniques which provide emergency access to an autonomous vehicle, while also preventing unauthorized access to make it more difficult to vandalize and/or steal the autonomous vehicle.

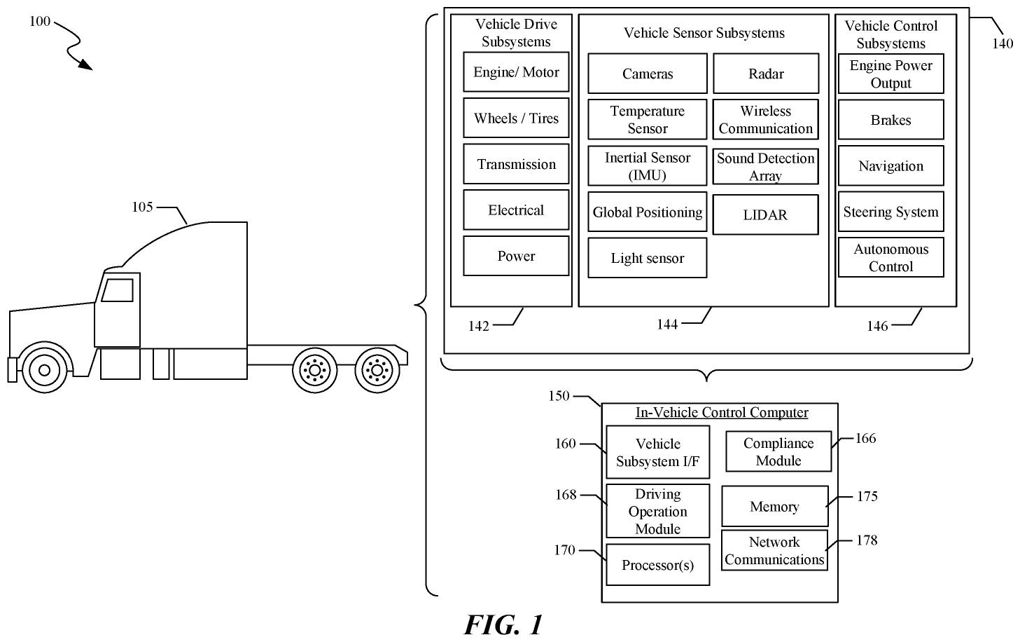

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the tractor 105 moves. The tractor 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous truck 105, including those which would indicate a malfunction in the AV or another cause for an AV to perform a limited or minimal risk condition (MRC) maneuver. The sensors for general operation of the autonomous vehicle may include cameras, a temperature sensor, an inertial sensor (IMU), a global positioning system (GPS), a light sensor, a LIDAR system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous truck 105. Microphones used may be any suitable type, mounted such that they are effective both when the autonomous truck 105 is at rest, as well as when it is moving at normal driving speeds.

Cameras included in the vehicle sensor subsystems 144 may be rear facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (i.e., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow the autonomous vehicle 105 to communicate with surrounding drivers or signal surrounding vehicles or drivers for safe operation of the autonomous vehicle 105.

An in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous truck 105 in response to information from the various vehicle subsystems 140. The one or more processors 170 execute the operations that allow the system to determine the health of the autonomous vehicle 105, such as whether the autonomous vehicle 105 has a malfunction or has encountered a situation requiring service or a deviation from normal operation and giving instructions. Data from the vehicle sensor subsystems 144 is provided to VCU 150 so that the determination of the status of the autonomous vehicle 105 can be made. The compliance module 166 determines what action should be taken by the autonomous truck 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous Control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The autonomous control vehicle control subsystem may receive a course of action to be taken from the compliance module 166 of the VCU 150 and consequently relay instructions to other subsystems to execute the course of action.

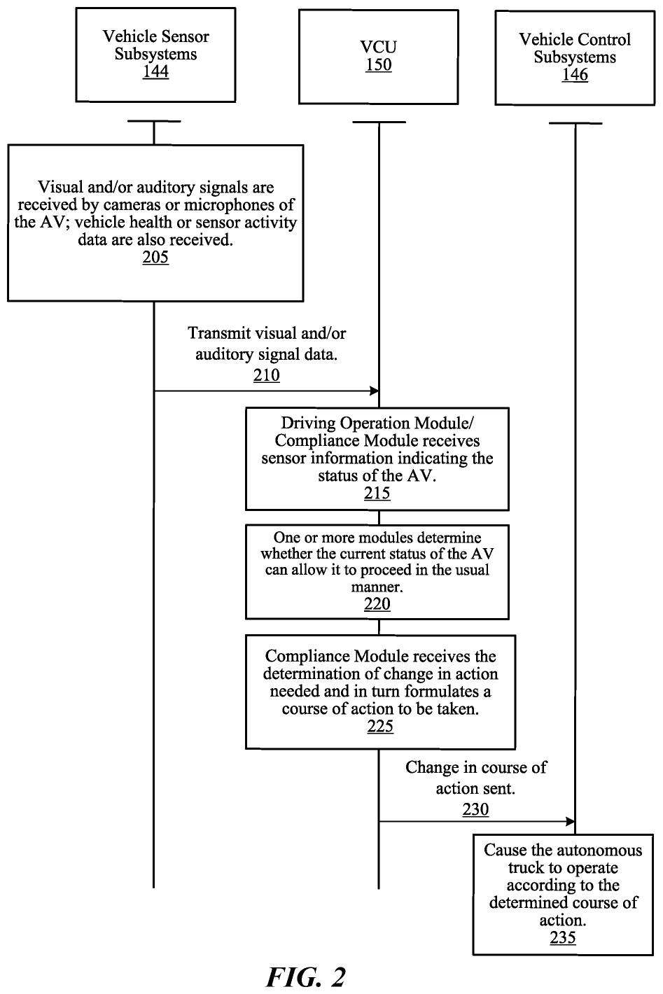

FIG. 2 shows a flow diagram for operation of an autonomous vehicle (AV) 105 safely in light of the health and surroundings of the autonomous vehicle 105. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

As shown in FIG. 2, the vehicle sensor subsystem 144 receives visual, auditory, or both visual and auditory signals indicating the at the environmental condition of the autonomous vehicle 105, as well as vehicle health or sensor activity data are received in step 205. These visual and/or auditory signal data are transmitted from the vehicle sensor subsystem 144 to the in-vehicle control computer system (VCU) 150, as in step 210. Any of the driving operation module and the compliance module receive the data transmitted from the vehicle sensor subsystem, in step 215. Then, one or both of those modules determine whether the current status of the autonomous vehicle 105 can allow it to proceed in the usual manner or that the autonomous vehicle 105 needs to alter its course to prevent damage or injury or to allow for service in step 220. The information indicating that a change to the course of the autonomous vehicle 105 is needed may include an indicator of sensor malfunction; an indicator of a malfunction in the engine, brakes, or other components necessary for the operation of the autonomous vehicle; a determination of a visual instruction from authorities such as flares, cones, or signage; a determination of authority personnel present on the roadway; a determination of a law enforcement vehicle on the roadway approaching the autonomous vehicle, including from which direction; and a determination of a law enforcement or first responder vehicle moving away from or on a separate roadway from the autonomous vehicle. This information indicating that a change to the AV's course of action is needed may be used by the compliance module to formulate a new course of action to be taken which accounts for the AV's health and surroundings, in step 225. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the VCU 150 to the autonomous control system, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

### Autonomous Vehicle Oversight System

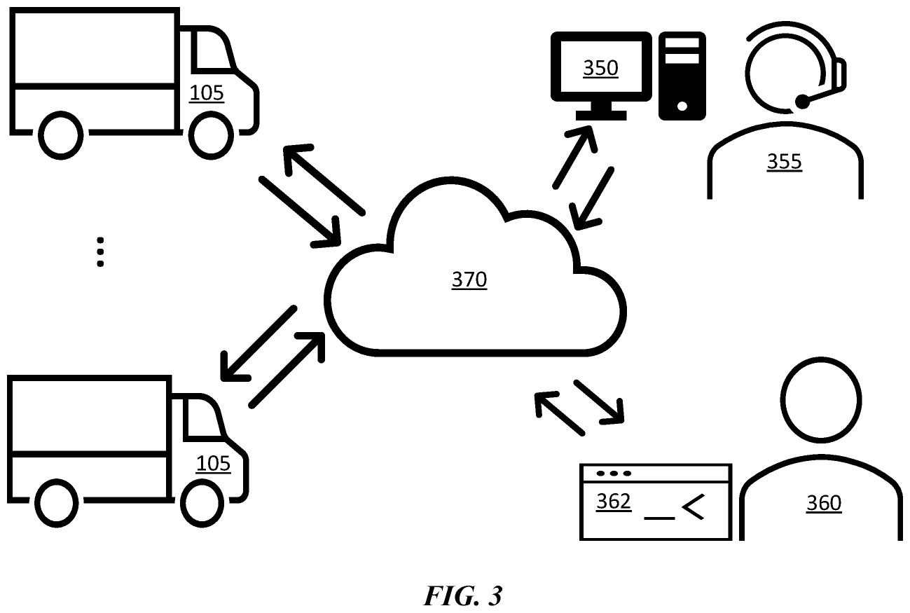

FIG. 3 illustrates a system 300 that includes one or more autonomous vehicles 105, a control center or oversight system 350 with a human operator 355, and an interface 362 for third party 360 interaction. A human operator 355 may also be known as a remoter center operator (RCO). Communications between the autonomous vehicles 105, oversight system 350 and user interface 362 take place over a network 370. In some instances, where not all the autonomous vehicles 105 in a fleet are able to communicate with the oversight system 350, the autonomous vehicles 105 may communicate with each other over the network 370 or directly. As described with respect to FIG. 1, the VCU 150 of each autonomous vehicle 105 may include a module for network communications 178.

An autonomous vehicle 105 may be in communication with the oversight system 350. The oversight system 350 may serve many purposes, including: tracking the progress of one or more autonomous vehicles 105 (e.g., an autonomous truck); tracking the progress of a fleet of autonomous vehicles 105; sending maneuvering instructions to one or more autonomous vehicles 105; monitoring the health of the autonomous vehicle(s) 105; monitoring the status of the cargo of each autonomous vehicle 105 in contact with the oversight system 350; facilitate communications between third parties (e.g., law enforcement, clients whose cargo is being carried) and each, or a specific, autonomous vehicle 105; allow for tracking of specific autonomous vehicles 105 in communication with the oversight system 350 (e.g., third party tracking of a subset of vehicles in a fleet); arranging maintenance service for the autonomous vehicles 105 (e.g., oil changing, fueling, maintaining the levels of other fluids); alerting an affected autonomous vehicle 105 of changes in traffic or weather that may adversely impact a route or delivery plan; pushing over the air updates to autonomous vehicles 105 to keep all components up to date; and other purposes or functions that improve the safety for the autonomous vehicle 105, its cargo, and its surroundings. An oversight system 350 may also determine performance parameters of the autonomous vehicle 105 (e.g. an autonomous truck), including any of: data logging frequency, compression rate, location, data type; communication prioritization; how frequently to service the autonomous vehicle 105 (e.g., how many miles between services); when to perform a minimal risk condition (MRC) maneuver while monitoring the vehicle's progress during the maneuver; when to hand over control of the autonomous vehicle 105 to a human driver (e.g., at a destination yard); ensuring the autonomous vehicle 105 passes pre-trip inspection; ensuring the autonomous vehicle 105 performs or conforms to legal requirements at checkpoints and weight stations; ensuring the autonomous vehicle 105 performs or conforms to instructions from a human at the site of a roadblock, cross-walk, intersection, construction, or accident; and the like.

To allow for communication between autonomous vehicles 105 in a fleet and the oversight system 350, each autonomous vehicle 105 may be equipped with a communication gateway. The communication gateway may have the ability to do any of the following: allow for AV to oversight system communication (i.e. V2C) and the oversight system to AV communication (C2V); allow for AV to AV communication within the fleet (V2V); transmit the availability or status of the communication gateway; acknowledge received communications; ensure security around remote commands between the autonomous vehicle 105 and the oversight system 350; convey the autonomous vehicle's location reliably at set time intervals; enable the oversight system 350 to ping the autonomous vehicle 105 for location and vehicle health status; allow for streaming of various sensor data directly to the oversight system 350; allow for automated alerts between the autonomous vehicle 105 and the oversight system 350; comply to ISO 21434 standards; and the like.

The oversight system 350 may be operated by one or more human, also known as an operator or a remote center operator (RCO) 355. The operator 355 may set thresholds for autonomous vehicle health parameters, so that when an autonomous vehicle 105 meets or exceeds the threshold, precautionary action may be taken. Examples of vehicle health parameters for which thresholds may be established by the operator 355 may include any of: fuel levels; oil levels; miles traveled since last maintenance; low tire-pressure detected; cleaning fluid levels; brake fluid levels; responsiveness of steering and braking subsystems; Diesel exhaust fluid (DEF) level; communication ability (e.g., lack of responsiveness); positioning sensors ability (e.g., GPS, IMU malfunction); impact detection (e.g., vehicle collision); perception sensor ability (e.g., camera, LIDAR, radar, microphone array malfunction); computing resources ability (e.g., VCU or ECU malfunction or lack of responsiveness, temperature abnormalities in computing units); angle between a tractor and trailer of the autonomous vehicle 105 in a towing situation (e.g., tractor-trailer, 18-wheeler, or semi-truck); unauthorized access by a living entity (e.g., a person or an animal) to the interior of the autonomous vehicle 105; and the like. The precautionary action may include execution of a minimal risk condition (MRC) maneuver, seeking service, or exiting a highway or other such re-routing that may be less taxing on the autonomous vehicle 105. An autonomous vehicle 105 whose system health data meets or exceeds a threshold set at the oversight system 350 or by the operator 355 may receive instructions that are automatically sent from the oversight system 350 to perform the precautionary action.

The operator 355 may be made aware of situations affecting one or more autonomous vehicles 105 in communication with or being monitored by the oversight system 350 that the affected autonomous vehicle(s) 105 may not be aware of. Such situations may include: irregular or sudden changes in traffic flow (e.g., traffic jam or accident); abrupt weather changes; abrupt changes in visibility; emergency conditions (e.g., fire, sink-hole, bridge failure); power outage affecting signal lights; unexpected road work; large or ambiguous road debris (e.g., object unidentifiable by the autonomous vehicle); law enforcement activity on the roadway (e.g., car chase or road clearing activity); and the like. These types of situations that may not be detectable by an autonomous vehicle 105 may be brought to the attention of the operator 355 through traffic reports, law enforcement communications, data from other vehicles that are in communication with the oversight system 350, reports from drivers of other vehicles in the area, and similar distributed information venues. The autonomous vehicle 105 may not be able to detect such situations because of limitations of sensor systems or lack of access to the information distribution means (e.g., no direct communication with weather agency). An operator 355 at the oversight system 350 may push such information to affected autonomous vehicles 105 that are in communication with the oversight system 350. The affected autonomous vehicles 105 may proceed to alter their route, trajectory, or speed in response to the information pushed from the oversight system 350. In some instances, the information received by the oversight system 350 may trigger a threshold condition indicating that MRC (minimal risk condition) maneuvers are warranted; alternatively, or additionally, an operator 355 may evaluate a situation and determine that an affected autonomous vehicle 105 should perform an MRC maneuver and subsequently send such instructions to the affected vehicle. In these cases, each autonomous vehicle 105 receiving either information or instructions from the oversight system 350 or the operator 355 uses its on-board computing unit (i.e. VCU) to determine how to safely proceed, including performing an MRC maneuver that includes pulling-over or stopping.

### Systems and Methods for Granting Access to Autonomous Vehicles in an Emergency

As described herein, in an emergency situation an autonomous vehicle 105 may need to terminate autonomous navigation, which can involve stopping the autonomous vehicle 105 and/or pulling over to the side of the road. Example emergency situations include unsafe environmental conditions, mechanical/electrical malfunctions of the autonomous vehicle 105, and/or being stopped by a law enforcement office (LEO). In some situations, the autonomous vehicle 105 can be configured to perform an MRC maneuver in which the autonomous vehicle 105 autonomously maneuvers to a stopping location. Depending on the implementation, the MRC maneuver can be performed under supervision of an operator 355 via the oversight system 350.

Since the autonomous vehicle 105 can operate without anyone present in the vehicle 105, it can be desirable to limit access to the autonomous vehicle 105 when stopped in order to prevent vandalism and/or theft of the autonomous vehicle 105. However, in order to comply with local laws and/or regulations, it may still be necessary to allow access and/or communication between a LEO or other authorized third party (e.g., service technician, tow truck operator, etc.) and the autonomous vehicle 105. For example, if a LEO pulls over the autonomous vehicle 105, it may be necessary to provide certain documents consistent with a traffic stop (e.g. license, registration, and/or insurance). Thus, without systems and techniques to authenticate a LEO or other authorized third party, the autonomous vehicle 105 may be vulnerable to malicious third parties.

In some embodiments, the autonomous vehicle 105 can be configured to physically prevent unauthorized access to the autonomous vehicle 105, particularly the vehicle cab, while still allowing access for a service technician or LEO to take control of the autonomous vehicle 105 when needed. One way in which authorized users can be granted access to the autonomous vehicle 105 while preventing others from gaining access is to provide the oversight system 350 with the ability to verify authorized users.

In certain emergency situations, an autonomous vehicle 105 may respond by pulling over to the side of the road and disabling certain functions (e.g., autonomous navigation, access to the cab of the autonomous vehicle 105, etc.). In these situations, a LEO or other authorized user may request access to controls of the autonomous vehicle 105 to either disable the autonomous vehicle 105 completely or direct the autonomous vehicle 105 manually to a safe location. As described herein, the autonomous vehicle 105 may grant access to the autonomous vehicle 105 including the controls for driving the autonomous vehicle 105 after authorizing the user via information exchange with the oversight system 350 and/or remote operator 355.

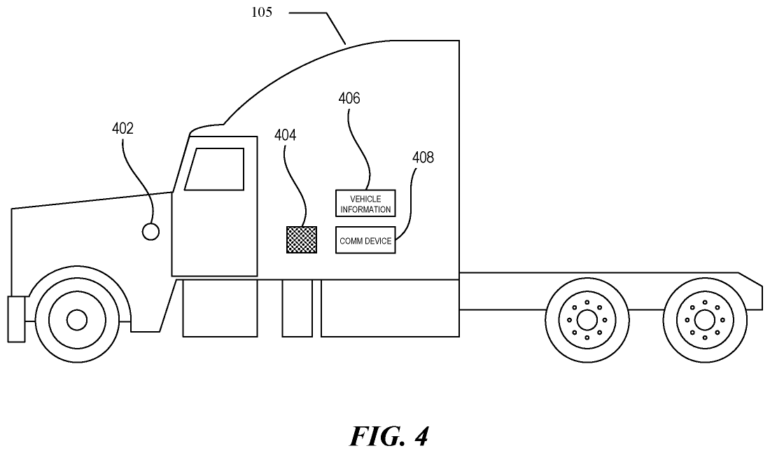

Aspects of this disclosure provide systems and methods for granting access to the autonomous vehicle 105 when the autonomous vehicle 105 is stopped. FIG. 4 illustrates an example autonomous vehicle 105 having one or more components configured to grant access to the autonomous vehicle 105 in accordance with aspects of this disclosure.

With reference to FIG. 4, the autonomous vehicle 105 can include one or more of the following: an access sensor 402, a quick response (QR) code 404, vehicle information 406 readable by an authorized user (e.g., a LEO or other third party), and a communication device 408. When included, each of the access sensor 402, the QR code 404, and the vehicle information 406 may be located on any visible portion of the autonomous vehicle 105. In certain embodiments, the visible portion is an exterior surface of the autonomous vehicle 105. In certain embodiments, the visible portion is an interior surface (e.g., dashboard, etc.) of the autonomous vehicles 105 that is visible from outside the autonomous vehicle 105. Thus, the location of these components 402-406 illustrated in FIG. 4 are merely examples and aspects of this disclosure are not limited thereto.

The access sensor 402 can be configured to detect and read an electromagnetic signal from a device of the authorized user. The electromagnetic signal can include user credentials that identify the authorized user and can be used to authenticate the authorized user and provide access to the autonomous vehicle 105. For example, the authorized user may have a credential badge or fob which can be read by the access sensor 402 when placed within a detection range of the access sensor 402. For example, the access sensor 402 can implement a short range wireless communication technology, such as near-field communication (NFC), short-range radio communication, radio frequency identification (RFID), etc. In some implementations, the access sensor 402 may also be configured to detect an electronic signal including the user credentials from the authorized user's mobile device or other handheld device, for example, using NFC communications.

The access sensor 402 may confirm that the user is authorized by providing the user credentials to a database. The database may be located local on the autonomous vehicle 105, or located remotely, for example, at the oversight system 350 and/or at an organization to which the authorized user belongs. In response to the database indicating that the user is authorized to access the autonomous vehicle 105, the autonomous vehicle 105 can unlock the doors of the autonomous vehicle 105 providing the user access to the cab.

The QR code 404 is configured to be scanned via a camera of the authorized user's mobile device. When scanned by the mobile device, the QR code 404 is configured to direct the authorized user's mobile device to a webpage that provides access to a method for authenticating the authorized user. For example, the webpage may provide one or more fields that allow the authorized user to input information that can be used to authenticate the authorized user (e.g., name, badge number, 2FA code, etc.).

In another embodiment, the webpage may also facilitate two-way communication with an operator 355 at the oversight system 350, e.g., by provide a phone number that the authorized user can call, establishing a voice and/or video call with the operator 355, etc. The authorized user can provide the authentication information to the operator 355 over the two-way communication. The QR code 404 can also encode information identifying the autonomous vehicle 105, which can be included in the webpage submission, or communicated from the user's mobile device to the oversight system 350 in response to the user scanning the QR code 404. Thus, the operator 355 can identify the particular autonomous vehicle 105 without requiring the user to relay this information to the operator 355.

In addition or in place of the QR code 404, the vehicle information 406 can include human-readable contact information for establishing two-way communication between the authorized user and the operator 355. For example, the vehicle information 406 can provide a phone number that the authorized user can call to establish two-way communication with the operator 355. The vehicle information 406 can also include identification information for the autonomous vehicle 105 that the authorized user can relay to the operator 355 to identify the particular autonomous vehicle 105.

The authorized user can also establish a two-way communication with the operator 355 via the communication device 408. The communication device 408 can include a microphone and speaker configured to provide voice communications via the network communications subsystem 178. In some embodiments, the communication device 408 can also include a camera and display to enable a video call with the operator 355.

The operator 355 can enter the information received from the user into the database and receive a response from the database indicating whether the user is authorized to access the autonomous vehicle 105. In other embodiments, when the user's information is not present in the database, the operator 355 can also confirm whether the user is authorized via an auxiliary process. In some embodiments, the operator 355 can contact the organization to which the user belongs to confirm whether the user is actually associated with the organization and whether the user is currently on duty in an area in which the autonomous vehicle 105 is stopped.

For example, when the authorized user is a LEO, the operator 355 can contact the law enforcement agency with which the LEO is employed to confirm that the LEO is employed by the law enforcement agency, the LEO is currently on duty, and/or the LEO is deployed to an area in which the autonomous vehicle is stopped 105. The autonomous vehicle 105 and the oversight system 350 can also be configured to mitigate LEO spoofing (e.g., an individual pretending to be a LEO to gain access to the autonomous vehicle 105). For example, the oversight system 350 may be configured to use two-factor authentication (2FA) through the law enforcement agency to authenticate the LEO. The oversight system 350 can provide a 2FA code to the law enforcement agency, and the LEO can receive the 2FA code from the law enforcement agency. The LEO can then provide the 2FA code back to the oversight system 350, thereby confirming that the LEO is not being spoofed. If the incorrect 2FA code is received, the oversight system 350 may provide the LEO a number of additional attempts to input the correct 2FA code before locking down the autonomous vehicle 105 and preventing any further access to the autonomous vehicle 105. The autonomous vehicle 105 may contact an emergency response team to respond to and/or recover the autonomous vehicle 105.

After the oversight system 350 and/or operator 355 has confirmed that the LEO is authorized to access the autonomous vehicle 105, the operator 355 can send a command to the autonomous vehicle 105 to unlock the doors of the autonomous vehicle 105 providing the user access to the cab.

The oversight system 350 can also cross-reference information received from the autonomous vehicle 105 before granting the authorized user access to the autonomous vehicle 105. For example, the oversight system 350 can receive location information and/or a confirmation that the autonomous vehicle 105 is in an emergency condition from the autonomous vehicle 105. The oversight system 350 can then confirm that the autonomous vehicle 105 is located at substantially the same location as the authorized user and that the autonomous vehicle 105 is in an emergency condition prior to granting access to the autonomous vehicle 105.

In the example of a LEO pulling over the autonomous vehicle 105, the autonomous vehicle 105 communicates to the LEO that the vehicle 105 is autonomous. This can be accomplished via signage on the side of the autonomous vehicle 105, via a speaker on the exterior of the autonomous vehicle 105, etc. After the LEO has been granted access to the autonomous vehicle 105, the autonomous vehicle 105 can open a glove box with the documents necessary for a traffic stop (e.g. license, registration, and/or insurance). The autonomous vehicle 105 can also receive a confirmation from the LEO that the traffic stop is complete, and in response, resume driving the autonomous vehicle 105.

The autonomous vehicle 105 and/or the oversight system 350 can further be configured to allow the authorized user to designate access to the autonomous vehicle 105 to a third party. For example, a LEO may designate access to the autonomous vehicle 105 to a tow truck operator when the autonomous vehicle 105 must be towed from the scene. In some embodiments, the autonomous vehicle 105 can communicate (e.g., via a display and/or audio) that the autonomous vehicle 105 requires a tow due to being broken down or being involved in an accident. In some embodiments, the LEO can send a request to designate a third party with access to the autonomous vehicle 105 to the oversight system 350 using the LEO's mobile device and/or the communication device 408. The oversight system 350 can then grant the third party access to the autonomous vehicle 105 and send a command to the autonomous vehicle 105 to provide access to the third party. Access may be granted to a third party by the oversight system 350 using various authentication methods including any of: transmission of the identification of the third party selected by the LEO to the oversight system which in turn sends a text message with a code or password that is input into a human-machine interface on the autonomous vehicle 105 by the third party; transmission of the identification of the third party selected by the LEO to the oversight system which in turn verifies the location of the third party's location by being given access location data from a mobile device or vehicle associated with the third party; transmission of the identification of the third party selected by the LEO to the oversight system which in turn sends a visual code (e.g., QR code, bar code) or randomly generated visual key to the third party's mobile device and the third party presents the visual code to the autonomous vehicle 105 through a camera associated with a human-machine interface on the autonomous vehicle 105; transmission of the identification of the third party selected by the LEO to the oversight system which in turn sends an audio cue or audio key sent to a mobile device associated with the third party which is played for the autonomous vehicle 105 such that a microphone array on the autonomous vehicle 105 detects the audio key and along with location information confirms the presence of an authorized third party; preauthorization of known third parties who are entrusted with a physical authentication implement (e.g., RFID or NFC key card, a dongle, a two-factor authentication code generator) and the physical authentication implement may be limited to those associated with a the identification of the third party selected by the LEO that is sent to the oversight system; preauthorization of known third parties whose biometric data is provided to the oversight system and/or autonomous vehicle in a database so that upon communication by law enforcement to the oversight system which third party is going to assist the autonomous vehicle only biometric data associated with the selected third-party will unlock the autonomous vehicle, and the like.

The autonomous vehicle 105 and/or the oversight system 350 can further be configured to revoke access to the autonomous vehicle 105 under certain circumstances. For example, in some embodiments, the autonomous vehicle 105 is configured to revoke access to the autonomous vehicle 105 after a predetermined time limit has expired since access to the autonomous vehicle 105 was granted. Prior to revoking access, the autonomous vehicle 105 may inform the authorized user that access will be revoked and provide the authorized user the option to extend the amount of time available before revoking access. The authorized user may be able to provide the input to extend access via, for example, a user interface inside a cab of the autonomous vehicle 105 and/or via the authorized user's mobile device.

In other situations, the oversight system 350 may command the autonomous vehicle 105 to revoke access prior to the predetermined time limit expiring. For example, the oversight system 350 and/or operator 355 may determine that the user has spoofed an authorized user and is not authorized to gain access to the autonomous vehicle 105. In this situation, the autonomous vehicle 105 can revoke access to the autonomous vehicle 105 including preventing the control inputs (e.g., steering wheel, pedals, etc.) of the autonomous vehicle 105 from controlling the autonomous vehicle 105 and locking the doors from opening from the outside. This can prevent a malicious user from driving the autonomous vehicle 105 any further and limit the malicious user's ability to vandalize the autonomous vehicle 105.

The operator 355 can also revoke access to the autonomous vehicle 105 independently of the automated revocation performed by the oversight system 350. In some embodiments, the operator 355 can monitor the information received from one or more sensors (e.g., the vehicle sensor subsystems 144) on the autonomous vehicle 105 to determine whether access to the autonomous vehicle 105 should be revoked. For example, the operator 355 can monitor the location of the autonomous vehicle 105 as measured by the GPS to determine whether the autonomous vehicle 105 is being driven in a suspicious location. As another example, the operator 355 may be able to monitor one or more cameras providing a view of the inside of the cab to determine whether the user is acting suspiciously in determining whether to revoke access to the autonomous vehicle 105.

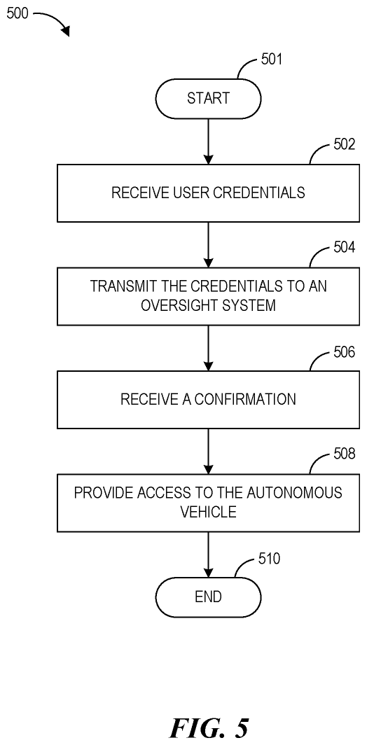

FIG. 5 is a flowchart illustrating a method 500 for granting access to an autonomous vehicle 105 in accordance with aspects of this disclosure. With reference to FIG. 5, one or more blocks of the method 500 may be implemented, for example, by a processor of the autonomous vehicle 105. The method 500 begins at block 501.

At block 502, the autonomous vehicle 105 receives user credentials from the authorized user. Depending on the situation, the autonomous vehicle 105 can receive the user credentials from the access sensor 402 and/or the communication device 408. In other situations, the autonomous vehicle 105 can facilitate the authorized user to provide the user credentials directly to the oversight system 350 and/or operator 355 via the QR code 404 and/or the vehicle information 406.

At block 504, the autonomous vehicle 105 transmits the user credentials to the oversight system 350. Depending on the embodiment, this may involve transmitting the user credentials received via the access sensor 402 and/or establishing two-way communications between the authorized user and an operator 355 via the communication device 408.

At block 506, the autonomous vehicle 105 receives a confirmation from the oversight system 350 that the authorized user is authorized to access the autonomous vehicle 105. At block 508, the autonomous vehicle 105 provides access to the autonomous vehicle 105, for example, by unlocking the doors to the cab of the autonomous vehicle 105. The method 500 ends at block 510.

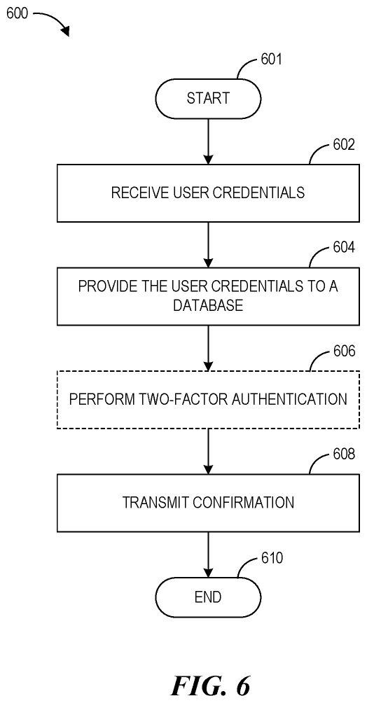

FIG. 6 is a flowchart illustrating a method 600 for confirming that an authorized user is authorized to access an autonomous vehicle 105 in accordance with aspects of this disclosure. With reference to FIG. 6, one or more blocks of the method 600 may be implemented, for example, by a processor of the oversight system 350. The method 600 begins at block 601.

At block 602, the oversight system 350 receives user credentials for an authorized user requesting access to an autonomous vehicle 105 from the autonomous vehicle 105 and/or the authorized user. As discussed above, depending on the situation the autonomous vehicle 105 can receive the user credentials from the access sensor 402 and/or the communication device 408 and provide the received user credentials to the oversight system 350. In other situations, the autonomous vehicle 105 can facilitate the authorized user to provide the user credentials directly to the oversight system 350 and/or operator 355 via the QR code 404 and/or the vehicle information 406. The oversight system 350 can also receive the user credentials from the authorized user over a two-way communication established via the authorized user's mobile device.

At block 604, the oversight system 350 can provide the user credentials to a database and receive a response from the database indicating whether the user is authorized to access the autonomous vehicle 105. In some embodiments, the oversight system 350 can maintain a database of authorized users, and in response to the credentials matching a user in the database, the database will return a response indicating that the user is authorized to access the autonomous vehicle 105. However, there may also be authorized users (e.g., LEOs) which are not entered into the database. Thus, the oversight system 350 can further provide the user credentials to an external database maintained by a third party entity (e.g. a law enforcement agency). When the user credentials are associated with a law enforcement agency that does not have a database, the operator 355 can contact the law enforcement agency to determine whether the authorized user is authorized to access the autonomous vehicle 105.

At block 606, the oversight system 350 can optionally perform two-factor authorization (2FA) through the law enforcement agency to authenticate the LEO. The oversight system 350 can provide a 2FA code to the law enforcement agency, and the LEO can receive the 2FA code from the law enforcement agency. The LEO can then provide the 2FA code back to the oversight system 350, thereby confirming that the LEO is not being spoofed.

At block 608, the oversight system 350 transmits the confirmation that the authorized user is authorized to access the autonomous vehicle 105 to the autonomous vehicle 105. The method 600 ends at block 610.

### CONCLUSION

Though much of this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. An autonomous vehicle comprising:
an access sensor located on an exterior of the autonomous vehicle and configured to receive user credentials from an authorized user;
a door configured to provide access to the autonomous vehicle;
a network communications subsystem configured to communicate with a remote oversight system; and
a processor configured to:
receive the user credentials from the access sensor;
transmit the user credentials to the remote oversight system via the network communications subsystem;
receive a confirmation from the remote oversight system that the user credentials are associated with a user authorized to access the autonomous vehicle; and
unlock the door in response to receiving the confirmation to provide the user access to the autonomous vehicle.

2. The autonomous vehicle of claim 1, wherein the processor is further configured to:
transmit a location of the autonomous vehicle to the remote oversight system,
wherein the remote oversight system is configured to confirm that the autonomous vehicle is located at substantially a same location as the user prior to granting access to the autonomous vehicle.

3. The autonomous vehicle of claim 2, wherein the processor is further configured to:
transmit a confirmation that the autonomous vehicle is in an emergency condition to the remote oversight system,
wherein the remote oversight system is further configured to confirm that the autonomous vehicle is in the emergency condition prior to granting access to the autonomous vehicle.

4. The autonomous vehicle of claim 1, further comprising:
a quick response (QR) code on the autonomous vehicle, the QR code configured to be scanned by a mobile device and direct the mobile device to a webpage that provides access to a method for authenticating the user.

5. The autonomous vehicle of claim 4, wherein the QR code further encodes information identifying the autonomous vehicle, the mobile device configured to provide the information identifying the autonomous vehicle to the remote oversight system.

6. The autonomous vehicle of claim 4, wherein the QR code further encodes information to direct the mobile device to establish two-way communication with an operator at the remote oversight system.

7. The autonomous vehicle of claim 1, further comprising:
vehicle information located on a visible portion of the autonomous vehicle, the vehicle information comprising human-readable contact information for establishing two-way communication with an operator at the remote oversight system.

8. The autonomous vehicle of claim 7, wherein the vehicle information further includes a phone number to establish the two-way communication and identification information for the autonomous vehicle that the user can relay to the operator to identify the autonomous vehicle.

9. The autonomous vehicle of claim 1, further comprising:
a communication device configured to establish two-way communication with an operator at the remote oversight system.

10. The autonomous vehicle of claim 9, wherein the communication device comprises a microphone and a speaker.

11. An oversight system comprising:
a network communications subsystem configured to communicate with an autonomous vehicle; and
a processor configured to:
receive user credentials for a user requesting access to the autonomous vehicle via the network communications subsystem;
provide the user credentials to a database;
receive a response from the database indicating that the user is authorized to access the autonomous vehicle; and
transmit a confirmation that the user is authorized to access the autonomous vehicle to the autonomous vehicle via the network communications subsystem.

12. The oversight system of claim 11, wherein the processor is further configured to receive the user credentials from the autonomous vehicle.

13. The oversight system of claim 11, wherein the processor is further configured to receive the user credentials from a mobile device of the user.

14. The oversight system of claim 11, wherein the user is a law enforcement officer (LEO) associated with a law enforcement agency, and wherein the processor is further configured to:
request an operator to contact the law enforcement agency to confirm that the LEO is currently on duty and is deployed to an area in which the autonomous vehicle is stopped,
wherein transmitting the confirmation that the user is authorized to access the autonomous vehicle is further in response to receiving a confirmation that the LEO is currently on duty and is deployed to the area in which the autonomous vehicle is stopped.

15. The oversight system of claim 14, wherein the processor is further configured to:
provide a two-factor authentication (2FA) code to the law enforcement agency; and
receive the 2FA code from the LEO,
wherein transmitting the confirmation that the user is authorized to access the autonomous vehicle is further in response to receiving the 2FA code from the LEO.

16. The oversight system of claim 11, wherein the processor is further configured to:
receive a request from the user to designate a third party with access to the autonomous vehicle; and
transmit a command to the autonomous vehicle to grant access to the third party.

17. A method for granting access to an autonomous vehicle during an emergency, comprising:
receiving a user credentials from an access sensor of the autonomous vehicle;
transmitting the user credentials to a remote oversight system via a network communications subsystem of the autonomous vehicle;
receiving a confirmation from the remote oversight system that the user credentials are associated with a user authorized to access the autonomous vehicle; and
unlocking a door of the autonomous vehicle in response to receiving the confirmation to provide the user access to the autonomous vehicle.

18. The method of claim 17, further comprising revoking access to the autonomous vehicle after a predetermined amount of time since access to the autonomous vehicle was granted.

19. The method of claim 18, further comprising:
informing the user that access will be revoked; and
providing the user an option to extend the predetermined amount of time.

20. The method of claim 17, further comprising:
determining that the user has spoofed an authorized user and is not authorized to gain access to the autonomous vehicle; and
revoking access to the autonomous vehicle including preventing control inputs to the autonomous vehicle from controlling the autonomous vehicle and locking the door from opening from outside in response to determining that the user is not authorized to gain access to the autonomous vehicle.
